(19) United States
(12) Patent Application Publication
(10) Pub. No.: US 2006/0131973 A1
(43) Pub. Date: Jun. 22, 2006

(54) FAN

(75) Inventors: Yung-Yu Chiu, Taoyuan Hsien (TW); Shun-Chen Chang, Taoyuan Hsien (TW); Kuo-Cheng Lin, Taoyuan Hsien (TW); Wen-Shi Huang, Taoyuan Hsien (TW)

Correspondence Address: PAI PATENT & TRADEMARK LAW FIRM, 1001 FOURTH AVENUE, SUITE 3200, SEATTLE, WA, 98154, US

(73) Assignee: DELTA ELECTRONICS, INC., Taoyuan Hsien (TW)

(21) Appl. No.: 11/307,740

(22) Filed: Feb. 20, 2006

Related U.S. Application Data
(63) Continuation-in-part of application No. 10/799,420, filed on Mar. 12, 2004.

(30) Foreign Application Priority Data
Apr. 23, 2003 (TW) 92206497

(51) Int. Cl. H02K 7/00; H02K 5/00; H02K 11/00

(52) U.S. Cl. 310/91; 310/67 R

(57) ABSTRACT

A fan includes a fan base, a bearing assembly, a fan hub and a shaft. The fan hub is formed with an extrusion protruding from its top planar surface, and the shaft is fit into the bearing assembly and connected to the fan hub. The shaft has one end protruding from the top planar surface of the fan hub to form an extension portion, and the extension portion of the shaft is enclosed by and in close connection with the extrusion of the fan hub.

### CROSS-REFERRENCE TO RELATED APPLICATIONS

This application is a continuation-in-part of U.S. application Ser. No. 10/799,420, filed Mar. 12, 2004, which claims priority to Taiwan application 92206497, filed Apr. 23, 2003, now pending.

### BACKGROUND OF THE INVENTION

(a) Field of the Invention

The invention relates to a fan and, more particularly, to a fan capable of enhancing the connection strength between a fan hub and a shaft.

(b) Description of the Related Art

A fan hub is liable to fall off if the connection strength between the fan hub and the shaft is not high enough to withstand the continuous vibrations during long periods of operation.

A cross-sectional view of a conventional fan 100 is shown in FIG. 1. Referring to FIG. 1, when the shaft 102 is connected to the fan hub 104, the area of the contact surface P between the shaft 102 and the fan hub 104 determines the magnitude of the connection strength between them; more specifically, the latter increases as the former does.

Nowadays, designers continually make an effort to reduce the size of electrical products. Under these circumstances, a fan is designed to reduce its overall thickness to meet such requirements when being applied to thin-size electrical products. However, because the thickness of the bearing 106 cannot be further reduced and a predetermined clearance between the bearing seat 108 and the fan hub 104 must be maintained after assembly, the length of the contact surface P in the axial direction of the fan 100 must be shortened to meet the aforesaid requirement. Thus, sufficient connection strength between the shaft 102 and the fan hub 104 cannot be provided.

### BRIEF SUMMARY OF THE INVENTION

An object of the invention is to provide a fan capable of enhancing the connection strength between a fan hub and a shaft.

According to the design of the invention, a fan includes a fan base, a bearing assembly, a fan hub and a shaft. The fan hub is formed with an extrusion protruding from its top planar surface, and the shaft is fit into the bearing assembly and connected to the fan hub. The shaft has one end protruding from the top planar surface of the fan hub to form an extension portion enclosed by the extrusion of the fan hub.

Through the invention, since the fan hub is formed with an extrusion protruding from its outer planar surface, and the shaft is elongated and protrudes from the top planar surface of the fan hub or the bottom surface of the fan base, an additional contact area between the shaft and the fan hub is provided when the extension portion of the shaft is enclosed by and in close connection with the extrusion of the fan hub. Thus, the connection strength between the shaft and the fan hub is greatly enhanced.

### BRIEF DESCRIPTION OF THE DRAWINGS

FIG. 1 is a cross-sectional view schematically showing a conventional fan.

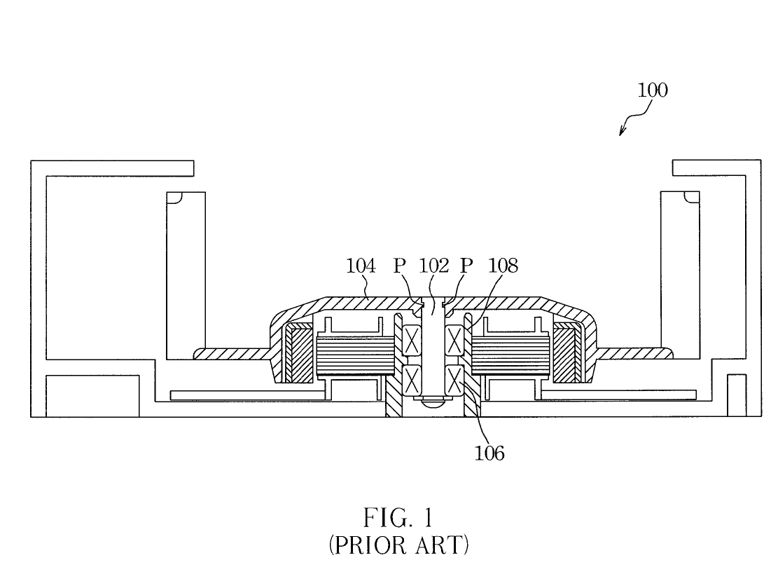

FIG. 2 is a cross-sectional view schematically showing a fan according to an embodiment of the invention.

FIG. 3 is a comparison diagram contrasting the fan exhibited in FIG. 2 with a conventional fan.

FIG. 4 is a cross-sectional view schematically showing a fan according to another embodiment of the invention.

FIG. 5 is a comparison diagram contrasting the fan exhibited in FIG. 4 with a conventional fan.

FIG. 6 is a cross-sectional view showing a modification of the fan shown in FIG. 4.

FIG. 7 is a cross-sectional view showing a fan according to another embodiment of the invention.

### DETAILED DESCRIPTION OF THE INVENTION

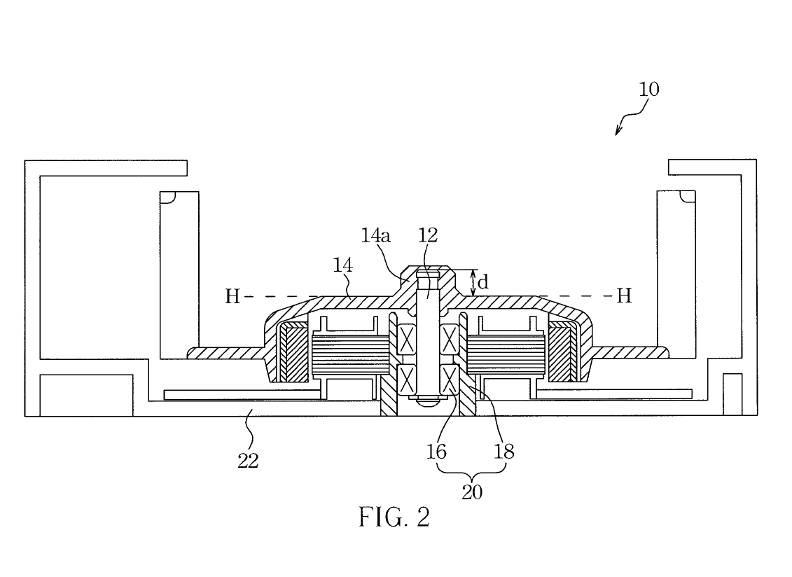

Referring to FIG. 2, according to an embodiment of the invention, a fan 10 includes a shaft 12 having a first end connected to a fan hub 14 and a second end fit into a bearing assembly 20. The bearing assembly 20 is mounted on a fan base 22 and includes a bearing 16 and a bearing seat 18 for accommodating and positioning the bearing 16.

In this embodiment, the fan hub 14 is formed with an extrusion 14a protruding from a top planar surface H of the fan hub 14 in its central location. The shaft 12 is also elongated to protrude upwards from the top planar surface H of the fan hub 14 to form an extension portion with a length d in the axial direction of the fan 10. Thereby, the extension portion of the shaft 12 is enclosed by and in close connection with the extrusion 14a of the fan hub 14. Specifically, the height of the extension portion of the shaft 12 is approximately equal to the height of extrusion 14a of the fan hub 14.

It should be understood that the extrusion 14a may be of any shape, such as a cup-shape shown in FIG. 2, as long as the extrusion 14a is in close connection with the extension portion of the shaft 12.

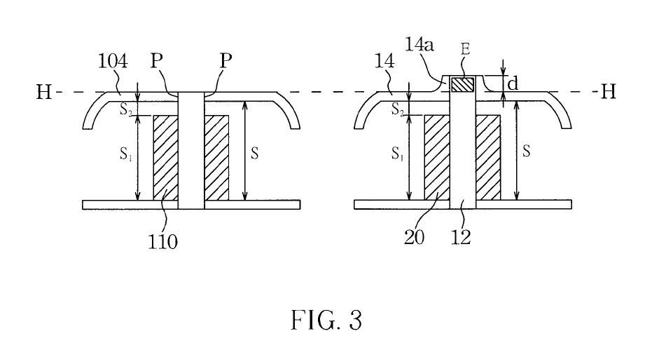

FIG. 3 is a comparison diagram contrasting the fan exhibited in FIG. 2 with a conventional fan.

The conventional fan is shown on the left-hand side of FIG. 3. According to the conventional design, since the bearing assembly 110, including the bearing 106 and the bearing seat 108, has a thickness of S₁ and needs to keep a predetermined distance S₂ from the fan hub 104 after assembly, it requires at least a space having a fixed length S (=S₁+S₂) in the axial direction of the fan. Consequently, since the length S can not be further reduced, the length of the contact surface P in the axial direction must be shortened to meet the requirement of thinning the motor structure, thus decreasing the connection strength between the shaft and the fan hub.

On the other hand, the fan of this embodiment is shown on the right-hand side of FIG. 3. In this embodiment, however, since the shaft 12 protrudes from the top planar surface H of the fan hub 14 and the fan hub is formed with an extrusion 14a, when the extension portion of the shaft 12 is enclosed by and in close connection with the extrusion 14a of the fan hub 14, an additional length d of the shaft 12 is provided to enlarge the contact area and to increase the connection strength as a result. In other words, the protrusion of the shaft functions as a reinforced connection part E to greatly increase the connection strength between the shaft and the fan hub in the fan. Further, the extension portion of the shaft 12 has a groove thereon to make the shaft 12 be securely fixed to the extrusion 14a of the fan hub 14.

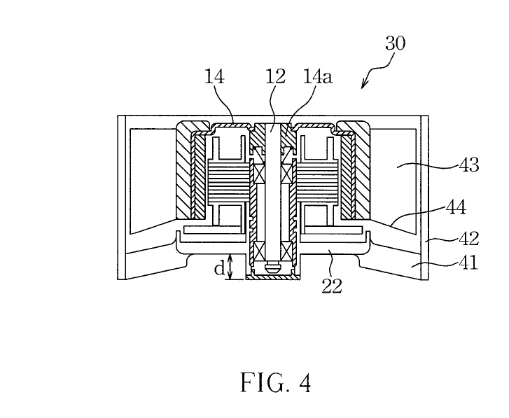

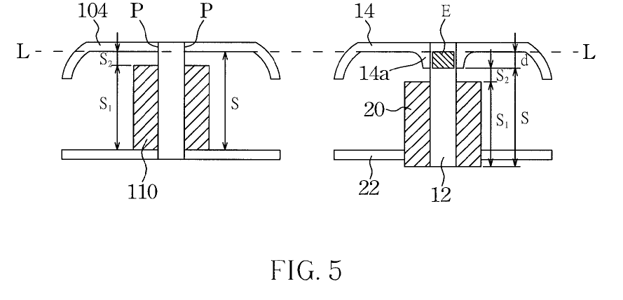

FIG. 4 is a cross-sectional view showing a fan 30 according to another embodiment of the invention. As shown in FIG. 4, the shaft 12 and the bearing assembly 20 may also protrude downwards from the bottom surface of the fan base 22 to form an extension portion having a length d in the axial direction of the fan 30. FIG. 5 is a comparison diagram contrasting the fan exhibited in FIG. 4 with a conventional fan. Referring to the right-hand side of FIG. 5, according to this embodiment, since the shaft 12 protrudes downwards from the bottom surface of the fan base 22, the required space having a length S in the axial direction moves downwards as the bearing assembly 20 is coupled to the downward extension portion of the shaft 12. Under these circumstances, the fan hub 14 is allowed to be formed with an extrusion 14a protruding from a bottom planar surface L of the fan hub 14 in its central location, without reducing the space required for the bearing assembly 20 after assembly. In other words, the downward protrusion of the shaft 12 makes it possible for the extrusion 14a to protrude from the bottom planar surface L of the fan hub 14, and, when the downward extrusion 14a is in close connection with the shaft 12, the contact area between the fan hub 14 and the shaft 12 is enlarged to increase the connection strength. It should be noted that fan base 22 in FIG. 4 includes ribs 41 disposed between the fan base 22 and a frame 42 and is higher than the bottom of the frame 42. Moreover, as shown in FIG. 4, blades 43 are disposed around the fan hub 14 and the bottom edges 44 of blades 43 are gradually and downward extended to the frame 42. Therefore, the shape of the bottom edges 44 changes according to the shape of the ribs 41.

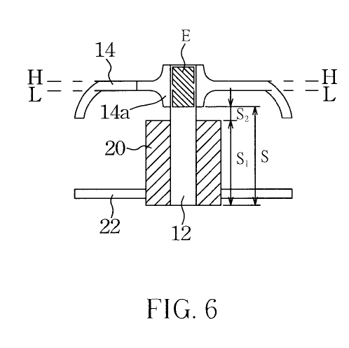

Referring to FIG. 6, there is shown a modification derived from the embodiment exhibited in FIG. 4, and the difference between them lies in that the fan hub 14 is formed with an extrusion 14a in its central location protruding from both the top planar surface H and the bottom planar surface L of the fan hub 14. Hence, the connection strength between the shaft 12 and the hub 14 can be further enhanced. Also, it is easy to understand from FIG. 6 that the extrusion 14a may, alternatively, protrude only from the top planar surface H.

Through the invention, since the fan hub is formed with an extrusion protruding from its outer planar surface, namely the top planar surface or the bottom planar surface, and the shaft is elongated and protrudes from the top planar surface of the fan hub or the bottom surface of the fan base, an additional contact area between the shaft and the fan hub is provided when the extension portion of the shaft is enclosed by and in close connection with the extrusion of the fan hub. Thus, the connection strength between the shaft and the fan hub is greatly enhanced.

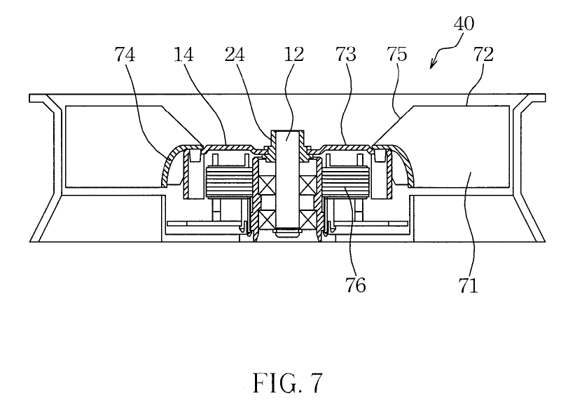

FIG. 7 is a cross-sectional view showing a fan 40 according to another embodiment of the invention. The fan 40 shown in FIG. 7 includes a sleeve 24 such as a copper sleeve embedded between the shaft 12 and the fan hub 14, and the shaft 12 has one end protruding from the top planar surface of the fan hub 14 to form an extension portion. Hence, one can also provide additional contact area between the shaft 12 and the sleeve 24 by extending the sleeve 24 upwards to enclose the extension portion of the shaft 12 to enhance the connection strength. Also, referring back to FIG. 4 again, the downward extrusion 14a of the fan hub 14 may be replaced with a sleeve embedded between the shaft 12 and the fan hub 14, and one can provide additional contact area between the shaft 12 and the sleeve simply by extending the sleeve downwards to enhance the connection strength between the shaft 12 and the fan hub 14. It should be noted that each of blades 71 includes a bevel edge 75 extending from an upper edge of fan hub 14 to form an upper edge 72 higher than the fan hub 14. Moreover, as shown in FIG. 7, the fan hub 14 includes a first part 73 and a second part 74 around the first part 73, wherein the first part 73 covers coils 76, and the blades 72 are set up to the second parts 74.

It is clear to one of ordinary skill in the art that the extension portion of the shaft is not limited to being connected to the extrusion of the fan hub or the sleeve, but may be connected to other members of the fan capable of providing a tight connection.

While the invention has been described by way of examples and in terms of preferred embodiments, it is to be understood that the invention is not limited to the disclosed embodiments. On the contrary, it is intended to cover various modifications. Therefore, the scope of the appended claims should be accorded the broadest interpretation so as to encompass all such modifications.

What is claimed is:

1. A fan comprising:
a fan base;
a bearing assembly mounted on the fan base;
a fan hub formed with an extrusion protruding from a top planar surface of the fan hub; and
a shaft fit into the bearing assembly and connected to the fan hub, the shaft having one end protruding from the top planar surface of the fan hub to form an extension portion enclosed by and in close connection with the extrusion of the fan hub;
wherein the extension portion of the shaft has a groove thereon to be securely fixed to the extrusion of the fan hub.

2. The fan according to claim 1, wherein the extrusion is formed in the central location of the fan hub.

3. The fan according to claim 1, wherein the extrusion is cup-shaped.

4. The fan according to claim 1, wherein the bearing assembly includes a bearing and a bearing seat for accommodating and positioning the bearing.

5. A fan comprising:
a frame;
a fan base, which is positioned higher than the bottom of the frame;
a bearing assembly mounted on the fan base;
a fan hub formed with an extrusion protruding from an outer planar surface of the fan hub;
a plurality of blades disposed around the fan hub; and
a shaft fit into the bearing assembly and connected to the fan hub, the bearing assembly and the shaft both protruding from the bottom surface of the fan base, and the shaft having one part enclosed by the extrusion of the fan hub.

6. The fan according to claim 5, wherein the outer planar surface is a top planar surface of the fan hub.

7. The fan according to claim 6, wherein the extrusion also protrudes from a bottom planar surface of the fan hub.

8. The fan according to claim 5, wherein the outer planar surface is a bottom planar surface of the fan hub.

9. The fan according to claim 5, wherein the extrusion is formed in the central location of the fan hub.

10. The fan according to claim 5, wherein the extrusion is cup-shaped.

11. The fan according to claim 5, wherein the bearing assembly includes a bearing and a bearing seat for accommodating and positioning the bearing.

12. The fan according to claim 5, further comprising at least one rib disposed between the fan base and the bottom of the frame, wherein the shape of an edge of the blade, facing the rib, corresponds to that of the rib.

13. A fan comprising:
a fan base;
a bearing assembly mounted on the fan base;
a fan hub;
a plurality of blades, each of the blades including a bevel edge extending from the fan hub to form an upper edge higher than the fan hub;
a shaft supported by the bearing assembly and connected to the fan hub; and
a sleeve embedded between the shaft and the fan hub.

14. The fan according to claim 13, wherein the sleeve is a copper sleeve.

15. The fan according to claim 13, wherein the bearing assembly includes a bearing and a bearing seat for accommodating and positioning the bearing.

16. The fan according to claim 15, wherein the outside diameter of the sleeve is smaller than the outside diameter of the bearing of the bearing assembly.

17. The fan according to claim 13, further comprising coils positioned around the bearing assembly, wherein the fan hub comprises a first part and a second part around the first part, the first part covers the coils, and the blades are set up to the second part.

18. The fan according to claim 13, wherein the shaft and the sleeve both protrude from a top planar surface of the fan hub.

19. The fan according to claim 13, wherein the sleeve protrudes from a bottom planar surface of the fan hub.
